(19) United States
(12) Patent Application Publication
(10) Pub. No.: US 2016/0375911 A1
(43) Pub. Date: Dec. 29, 2016

(54) METHOD AND ARRANGEMENT FOR ALLOWING SECONDARY TASKS DURING SEMI-AUTOMATED DRIVING

(71) Applicant: VOLVO CAR CORPORATION, Gothenburg (SE)

(72) Inventors: Erik COELINGH, Alvangen (SE); Jonas EKMARK, Olofstorp (SE)

(21) Appl. No.: 15/166,417

(22) Filed: May 27, 2016

(30) Foreign Application Priority Data
Jun. 23, 2015 (EP) 15173381.3

(51) Int. Cl. B60W 50/08; B60K 35/00; B60Q 9/00; G05D 1/00

(52) U.S. Cl. CPC B60W 50/082; G05D 1/0088; B60K 35/00; B60Q 9/00; B60W 2540/00; B60K 2350/352; B60W 2550/14

(57) ABSTRACT

A method and arrangement are disclosed for allowing secondary tasks during semi-automated driving of a road vehicle having an infotainment system including one or more display units, and a semi-automated driver assist system having one or more sensors for acquiring data of a road ahead. A confidence of the ability of the semi-automated driver assist system to control the road vehicle autonomously is determined from at least acquired data of the road ahead. A viewing direction of a driver of the road vehicle is determined using a driver monitoring camera. Autonomous control is allowed if the viewing direction of the driver is determined to be towards the road ahead or towards a display unit of the infotainment system and the confidence is determined to be above a confidence threshold, otherwise any ongoing autonomous control is cancelled and the driver urged to assume control of the road vehicle.

### CROSS-REFERENCE TO RELATED APPLICATIONS

This application claims foreign priority benefits under 35 U.S.C. §119(a)-(d) to European patent application number EP 15173381.3, filed Jun. 23, 2015, which is incorporated by reference in its entirety.

### TECHNICAL FIELD

Embodiments herein relate to a method and an arrangement for allowing secondary tasks during semi-automated driving of a road vehicle having an infotainment system which comprises one or more infotainment display units arranged in a passenger compartment thereof, and a semi-automated driver assist system comprising one or more sensors for acquiring data of a road ahead, as well as a road vehicle that comprises such an arrangement.

### BACKGROUND

Motor vehicles are increasingly being equipped with sensors which monitor the surrounding environment. This sensor information may be used to control the future trajectory of the road vehicle. This automation may range from a fully autonomous vehicle, where vehicle sensors monitor all feasible situations in the vehicle surroundings allowing for vehicle travel without driver supervision, to a driver controlled vehicle, where the sensor information is only used to inform the driver. In all levels of automation there is a need for safe driving, meaning in this case to plan and realize a vehicle trajectory with an acceptably low level of risk.

In a case where the automated function takes responsibility for a particular driving task, the automation system should be able to operate with a sufficiently low level of risk. This is the purpose of functional safety. This is challenging when the automation system uses sensors which have inherent limitations, e.g. cannot detect everything in the environment of the vehicle. This is why most automated functions rely on the fact that the driver of the vehicle is always responsible for safe operation of the vehicle and that the driver of the vehicle at any moment may regain control of the vehicle. Thus, in a situation where it is not possible to account for all feasible situations, the vehicle driver will have to at least monitor a semi-autonomous control, with a readiness to assume control of the vehicle.

A previously known document, DE102009046451, relates to a method, apparatus and computer program product that involve receiving face data via a camera interface, where the data represents a viewing direction of an occupant of a motor vehicle. The face data is classified, where verification takes place to check whether the viewing direction of the occupant is directed to an assembly area of an infotainment device during classification. A vision attention signal is output via a signal interface when the viewing direction of the occupant is directed to the assembly area of the infotainment device, so as to detect vision attention to the assembly area of the infotainment device. The information thus obtained can, for example, be used to adapt a warning strategy of a driver assistance system, since the driver is distracted when looking at the infotainment system. It may in such a case issue a Lane Departure Warning or turn on Lane Keeping Support or adjust the time gap of an ACC system, rendering improved safety and comfort.

Document DE102009046451, is based on the conception that the driver is distracted when looking at the infotainment system, and uses such detection of distraction for initiating a driver warning or driver assistance in order to mitigate any danger potentially caused by the driver distraction.

Thus, document DE102009046451 relates to the provision of countermeasures to potential dangers caused by driver distraction from a vehicle infotainment system, however it nowhere mentions how to facilitate driver usage of an on-board infotainment system.

### SUMMARY

Embodiments herein aim to provide an improved method for allowing secondary tasks during semi-automated driving of a road vehicle having an infotainment system which comprises one or more infotainment display units arranged in a passenger compartment thereof, and a semi-automated driver assist system comprising one or more sensors for acquiring data of a road ahead.

This is provided through a method comprising: determining, from at least the acquired data of the road ahead, a confidence of the ability of the semi-automated driver assist system to control the road vehicle autonomously; determining a viewing direction of a driver of the road vehicle using a driver monitoring camera; if the viewing direction of the driver of the road vehicle is determined to be towards the road ahead or towards an infotainment display unit of the infotainment system of the road vehicle and the confidence of the ability of the semi-automated driver assist system to control the road vehicle autonomously is determined to be above a confidence threshold, allowing autonomous control of the road vehicle by the semi-automated driver assist system; if, during ongoing autonomous control by the semi-automated driver assist system, the viewing direction of the driver of the road vehicle is determined not to be towards the road ahead or towards an infotainment display unit of the infotainment system of the road vehicle or the confidence of the ability of the semi-automated driver assist system to control the road vehicle autonomously is determined to be below a confidence threshold, cancelling the ongoing autonomous control by the semi-automated driver assist system and urging the driver of the road vehicle to assume control of the road vehicle.

The method, as above, provides for allowing a driver of an associated road vehicle to, in a safe manner, perform secondary tasks, using an infotainment system controlled by the vehicle, whilst being able to instantaneously bring the driver back into the control-loop should it be deemed necessary.

According to a second embodiment, the method further comprises discontinuing or fading-out any ongoing presentation on the infotainment display unit of the infotainment system of the road vehicle viewed by the driver upon urging the driver of the road vehicle to assume control of the road vehicle.

The provision of discontinuing or fading-out any ongoing presentation on the infotainment display unit will further contribute to returning the attention of a road vehicle driver to the task of driving.

According to a third embodiment, if the viewing direction of the driver of the road vehicle is determined to not be towards the road ahead or towards an infotainment display unit of the infotainment system of the road vehicle, but on a nomadic device or item, then cancelling any ongoing autonomous control by the semi-automated driver assist system and urging the driver to assume control of the road vehicle.

The provision of cancelling any ongoing autonomous control by the semi-automated driver assist system and urging the driver to assume control of the road vehicle if the viewing direction of the driver determined to be towards a nomadic device or item provides for improved traffic safety through preventing that a vehicle driver loses himself/herself using a smartphone, tablet PC or similar portable infotainment device, and therefore neglects the responsibilities associated with driving the vehicle.

According to a fourth embodiment, the method further comprises determining a fault status of the semi-automated driver assist system and if determined faulty, discontinuing or fading-out any ongoing presentation on the infotainment display unit of the infotainment system of the road vehicle viewed by the driver and urging the driver of the road vehicle to assume control of the road vehicle.

The provision of discontinuing or fading-out any ongoing presentation on the infotainment display unit viewed by the driver and urging the driver of the road vehicle to assume control if the semi-automated driver assist system is determined faulty further improve traffic safety through eliminating further travel control by a faulty system.

According to a fifth embodiment, the method further comprises determining a delay in the driver of the road vehicle to assuming control of the road vehicle following the driver of the road vehicle being urged to assume control of the road vehicle, and if the determined delay exceeds a predetermined delay threshold, causing the semi-automated driver assist system to go to a degraded mode and slow down the road vehicle autonomously.

The provision of slowing down the road vehicle autonomously should a driver not respond immediately to a request to take over the task of driving also further improve traffic safety through restricting further travel.

According to a sixth embodiment, the delay in the driver of the road vehicle assuming control of the road vehicle is determined from a delay in the viewing direction of the driver of the road vehicle being determined to be towards the road ahead following the driver of the road vehicle being urged to assume control of the road vehicle.

The provision of determining the delay from a delay in the viewing direction of the driver of the road vehicle being determined to be towards the road ahead following a request to take over the task of driving provides an efficient way of determining the delay.

According to a seventh embodiment, urging the driver of the road vehicle to assume control of the road vehicle comprises at least one of: presenting a takeover request to the infotainment display unit of the infotainment system of the road vehicle viewed by the driver; presenting a blackout screen to the infotainment display unit of the infotainment system of the road vehicle viewed by the driver; presenting an acoustic takeover request to an acoustic presentation unit of the road vehicle; presenting a haptic takeover request warning to a road vehicle driver contact surface of the road vehicle.

The provision of presenting a takeover request in one or more of the above ways contributes to further enhancing driver awareness and stress the urgency of a takeover.

Embodiments herein also aim to provide an improved arrangement for allowing secondary tasks during semi-automated driving of a road vehicle having an infotainment system which comprises one or more infotainment display units arranged in a passenger compartment thereof, and a semi-automated driver assist system comprising one or more sensors for acquiring data of a road ahead.

Thus, according to an eight embodiment, this is provided through an arrangement comprising a control unit arranged or configured to determine, from at least the acquired data of the road ahead, a confidence of the ability of the semi-automated driver assist system to control the road vehicle autonomously; a driver monitoring camera for determining a viewing direction of a driver of the road vehicle; the control unit further being arranged or configured to allow autonomous control of the road vehicle by the semi-automated driver assist system if the viewing direction of the driver of the road vehicle is determined to be towards the road ahead or towards an infotainment display unit of the infotainment system of the road vehicle and the confidence of the ability of the semi-automated driver assist system to control the road vehicle autonomously is determined to be above a confidence threshold; and cancel the ongoing autonomous control by the semi-automated driver assist system and urge the driver of the road vehicle to assume control of the road vehicle if, during ongoing autonomous control by the semi-automated driver assist system, the viewing direction of the driver of the road vehicle is determined not to be towards the road ahead or towards an infotainment display unit of the infotainment system of the road vehicle or the confidence of the ability of the semi-automated driver assist system to control the road vehicle autonomously is determined to be below a confidence threshold.

The arrangement, as above, provides for allowing a driver of an associated road vehicle to, in a safe manner, perform secondary tasks, using an infotainment system controlled by the vehicle, whilst being able to instantaneously bring the driver back into the control-loop should it be deemed necessary.

According to a ninth embodiment, the control unit further is arranged or configured to discontinue or fade-out any ongoing presentation on the infotainment display unit of the infotainment system of the road vehicle viewed by the driver upon urging the driver of the road vehicle to assume control of the road vehicle.

The provision of the control unit further being arranged or configured to discontinue or fade-out any ongoing presentation on the infotainment display unit will further contribute to returning the attention of a road vehicle driver to the task of driving.

According to a tenth embodiment, the control unit further is arranged or configured to cancel any ongoing autonomous control by the semi-automated driver assist system and urge the driver to assume control of the road vehicle if the viewing direction of the driver of the road vehicle is determined to not be towards the road ahead or towards an infotainment display unit of the infotainment system of the road vehicle, but on a nomadic device or item.

The provision of having the control unit cancel any ongoing autonomous control by the semi-automated driver assist system and urging the driver to assume control of the road vehicle if the viewing direction of the driver determined to be towards a nomadic device or item provides for improved traffic safety through preventing that a vehicle driver loses himself/herself using a smartphone, tablet PC or similar portable infotainment device, and therefore neglects the responsibilities associated with driving the vehicle.

According to an eleventh embodiment, the control unit further is arranged or configured to determine a fault status of the semi-automated driver assist system, and if determined faulty discontinue or fade-out any ongoing presentation on the infotainment display unit of the infotainment system of the road vehicle viewed by the driver and urge the driver of the road vehicle to assume control of the road vehicle.

The provision of arranging the control unit to discontinue or fade-out any ongoing presentation on the infotainment display unit viewed by the driver and urging the driver of the road vehicle to assume control if the semi-automated driver assist system is determined faulty further improve traffic safety through eliminating further travel control by a faulty system.

According to a twelfth embodiment, the control unit further is arranged or configured to determine a delay in the driver of the road vehicle assuming control of the road vehicle following the driver of the road vehicle being urged to assume control of the road vehicle, and if the determined delay exceeds a predetermined delay threshold, cause the semi-automated driver assist system to go to a degraded mode and slow down the road vehicle autonomously.

The provision of arranging the control unit to slow down the road vehicle autonomously should a driver not respond immediately to a request to take over the task of driving also further improve traffic safety through restricting further travel.

According to a thirteenth embodiment, the control unit further is arranged or configured to determine the delay in the driver of the road vehicle assuming control of the road vehicle from a delay in the viewing direction of the driver of the road vehicle being determined to be towards the road ahead following the driver of the road vehicle being urged to assume control of the road vehicle.

The provision of arranging the control unit to determine the delay from a delay in the viewing direction of the driver of the road vehicle being determined to be towards the road ahead following a request to take over the task of driving provides an efficient way of determining the delay.

According to a fourteenth embodiment, the control unit further is arranged or configured to urge the driver of the road vehicle to assume control of the road vehicle by at least one of: presenting a takeover request to the infotainment display unit of the infotainment system of the road vehicle viewed by the driver; presenting a blackout screen to the infotainment display unit of the infotainment system of the road vehicle viewed by the driver; presenting an acoustic takeover request to an acoustic presentation unit of the road vehicle; presenting a haptic takeover request warning to a road vehicle driver contact surface of the road vehicle.

The provision of arranging the control unit to present a takeover request in one or more of the above ways contributes to further enhancing driver awareness and stress the urgency of a takeover.

According to a final embodiment, a road vehicle is provided which comprises an arrangement as above.

A vehicle which comprises an arrangement as above is able to allow a driver thereof to, in a safe manner, perform secondary tasks, using an infotainment system controlled by the road vehicle, whilst being able to instantaneously bring the driver back into the control-loop should it be deemed necessary.

### BRIEF DESCRIPTION OF THE DRAWINGS

In the following, embodiments herein will be described in greater detail by way of example only with reference to attached drawings, in which

FIG. 1 is a schematic illustration of a method for allowing secondary tasks during semi-automated driving according to embodiments herein.

FIG. 2 is a schematic illustration of a road vehicle comprising an arrangement for allowing secondary tasks during semi-automated driving according to embodiments herein.

FIG. 3 is a schematic illustration of the passenger compartment of a road vehicle comprising an arrangement for allowing secondary tasks during semi-automated driving according to embodiments herein.

Still other features of embodiments herein will become apparent from the following detailed description considered in conjunction with the accompanying drawings. It is to be understood, however, that the drawings are designed solely for purposes of illustration and not as a definition of the limits hereof, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

In overview embodiments herein relate to a method and an arrangement for allowing secondary tasks during semi-automated driving of a road vehicle 1 having an infotainment system 2 which comprises one or more infotainment display units 3 arranged in a passenger compartment 4 thereof, and a semi-automated driver assist system 5 comprising one or more sensors 6 for acquiring data of a road ahead, as well as a road vehicle 1 that comprises such an arrangement.

Highly-automated road vehicles 1 allow drivers to spend time on secondary tasks such as reading or surfing the internet. However, this requires extensive redundancy in terms of sensing, computing and actuation in order to allow this in a safe way. Semi-automated driver assist systems 5, such as e.g. Pilot Assist and Traffic Jam Assist, do normally not have this redundancy but require the road vehicle 1 driver to be in the loop all the time, i.e. normally a semi-automated driver assist system 5 will assist in driving the road vehicle 1 during continuous supervision by the road vehicle 1 driver. Hence, there has earlier been no room for allowing secondary tasks. However, it is herein envisaged to allow a road vehicle 1 driver to perform other tasks whilst behind the steering wheel, this in particular as it is desirable to allow a road vehicle 1 driver to perform other tasks while behind the steering wheel of the road vehicle 1, without incurring the full cost of an extensively redundant automatic system.

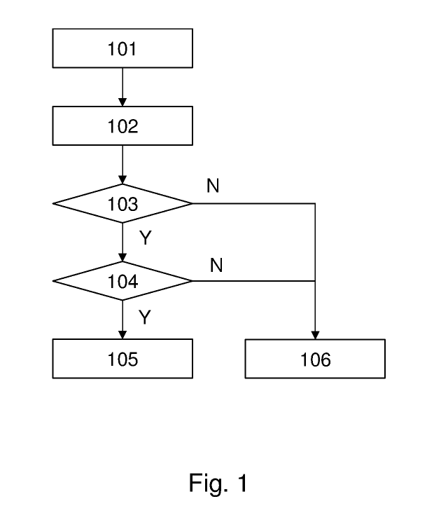

Firstly described herein is a method, as illustrated schematically in FIG. 1, that allows for limited secondary tasks, without requiring extensive redundancy. A basic principle is to provide a robust semi-automated driver assist system 5, such as e.g. Pilot Assist or Traffic Jam Assist, and allow the road vehicle 1 driver to use an in-vehicle infotainment system 2 display unit 3 while the semi-automated driver assist system 5 is sufficiently confident that the driver does not have to intervene in the control of the road vehicle 1, i.e. allowing the semi-automated driver assist system 5 to control the road vehicle 1 autonomously. Examples of such in-vehicle infotainment system 2 display units 3 include, but are not limited to, a Driver Information Module (DIM), Head Up Display (HUD) or Center Stack Display.

Increased robustness can e.g. be achieved by introducing additional sensors 6 and/or map data such that the semi-automated driver assist system 5 can deal with most traffic scenarios. Thus, in some embodiments the road vehicle 1 will be provided with the same or similar array of sensors 6 as a fully-automated road vehicle but will lack the extensive redundancy required in other road vehicle systems, e.g. brakes, thus enabling the same or an even higher confidence level by the semi-automatic system but at a lower cost than that for a fully-automated road vehicle.

Accordingly, as illustrated in FIG. 1, is provided a method for allowing secondary tasks during semi-automated driving of a road vehicle 1 having an infotainment system 2 which comprises one or more infotainment display units 3 arranged in a passenger compartment 4 thereof, and a semi-automated driver assist system 5 comprising one or more sensors 6 for acquiring data of a road ahead. The method comprises the steps of: 101 determining, from at least the acquired data of the road ahead, a confidence of the ability of the semi-automated driver assist system 5 to control the road vehicle 1 autonomously; 102 determining a viewing direction of a driver of the road vehicle 1 using a driver monitoring camera 7; and 103 if the viewing direction of the driver of the road vehicle 1 is determined to be towards the road ahead or towards an infotainment display unit 3 of the infotainment system 2 of the road vehicle 1 (indicated by Y in FIG. 1) and 104 the confidence of the ability of the semi-automated driver assist system 5 to control the road vehicle 1 autonomously is determined to be above a confidence threshold (indicated by Y in FIG. 1), 105 allowing autonomous control of the road vehicle 1 by the semi-automated driver assist system 5; and if, during ongoing autonomous control by the semi-automated driver assist system 5, 103 the viewing direction of the driver of the road vehicle 1 is determined not to be towards the road ahead or towards an infotainment display unit 3 of the infotainment system 2 of the road vehicle 1 (indicated by N in FIG. 1) or 104 the confidence of the ability of the semi-automated driver assist system 5 to control the road vehicle 1 autonomously is determined to be below a confidence threshold (indicated by N in FIG. 1), 106 cancelling the ongoing autonomous control by the semi-automated driver assist system 5 and urging the driver of the road vehicle 1 to assume control of the road vehicle 1.

Sensors 6 will determine if the road is clear and the driver monitoring camera 7 tracks whether the driver of the road vehicle 1 is using the in-vehicle infotainment system 2 for secondary tasks, such as e.g. reading, surfing etc. If this is determined with a sufficiently high confidence, the semi-automated driver assist system 5 will temporarily assume full control of the road vehicle 1. However, as soon as the confidence of the semi-automated driver assist system 5 drops below a certain threshold level, a warning and/or handover request urging the driver of the road vehicle 1 to assume control of the road vehicle 1 will be issued to the driver. Thus, as long as the eyes of the driver of the road vehicle 1 are directed towards an infotainment display unit 3 of the infotainment system 2, and the semi-automated driver assist system 5 is sufficiently confident, the driver can continue with the secondary task.

If the semi-automated driver assist system 5 has low confidence that it can continue controlling the road vehicle 1 autonomously, the in-vehicle infotainment will switch off and the driver is urged to take over immediately. Thus, in some embodiments the method further comprises discontinuing or fading-out any ongoing presentation on the infotainment display unit 3 of the infotainment system 2 of the road vehicle 1 viewed by the driver upon urging the driver of the road vehicle 1 to assume control of the road vehicle 1. Moreover, any ongoing presentation may be discontinued or faded-out on further infotainment display units 3 than the one viewed by the driver, possibly all infotainment display units 3 of the infotainment system 2 of the road vehicle 1.

For traffic safety it is not desirable that the road vehicle 1 driver loses himself/herself using a smartphone, tablet PC or similar portable infotainment device, and therefore neglects the responsibilities associated with driving the road vehicle 1. However, in accordance with the teachings herein, under certain circumstances the driver may be allowed performance of the same tasks using an infotainment system 2 controlled by the road vehicle 1. Therefore, if the driver does not look at the infotainment system 2 or not on the road, but e.g. on a nomadic device or item such as a smartphone, tablet PC or similar portable infotainment device or another portable device or item not controlled by the road vehicle 1, e.g. a book, a food item, a paper map, a shaver or similar, than any ongoing autonomous control by the semi-automated driver assist system 5 will be cancelled and the driver urged to take over. Thus, in yet some embodiments of the method, if the viewing direction of the driver of the road vehicle 1 is determined to not be towards the road ahead or towards an infotainment display unit 3 of the infotainment system 2 of the road vehicle 1, but on a nomadic device or item 8, than cancelling any ongoing autonomous control by the semi-automated driver assist system 5 and urging the driver to assume control of the road vehicle 1.

Should a system-error or fault occur during control of the road vehicle 1 by the semi-automated driver assist system 5 the in-vehicle infotainment is switched off and the driver is urged to take over immediately, in the same way as when the confidence of the system drops under the threshold level. Thus, according to still further embodiments the method further comprises determining a fault status of the semi-automated driver assist system 5 and if determined faulty, discontinuing or fading-out any ongoing presentation on the infotainment display unit 3 of the infotainment system 2 of the road vehicle 1 viewed by the driver and urging the driver of the road vehicle 1 to assume control of the road vehicle 1. Moreover, any ongoing presentation may be discontinued or faded-out on further infotainment display units 3 than the one viewed by the driver, possibly all infotainment display units 3 of the infotainment system 2 of the road vehicle 1.

If the driver does not take over immediately when urged to do so the semi-automated driver assist system 5 will go to a degraded mode and slow down the road vehicle 1 in a safe way, e.g. through throttling down a propulsion unit of the road vehicle 1 and possibly also by performing an autonomous braking action. Thus, in yet some embodiments the method further comprises determining a delay in the driver of the road vehicle 1 to assuming control of the road vehicle 1 following the driver of the road vehicle 1 being urged to assume control of the road vehicle 1, and if the determined delay exceeds a predetermined delay threshold, causing the semi-automated driver assist system 5 to go to a degraded mode and slow down the road vehicle 1 autonomously.

In some embodiments the delay in the driver of the road vehicle 1 assuming control of the road vehicle 1 is determined from a delay in the viewing direction of the driver of the road vehicle 1 being determined to be towards the road ahead following the driver of the road vehicle 1 being urged to assume control of the road vehicle 1. Thus, should the eyes of the road vehicle 1 driver be determined not to be on the road following the driver of the road vehicle 1 being urged to assume control of the road vehicle 1, the semi-automated driver assist system 5 will throttle down the propulsion unit of the road vehicle 1 and possibly also perform an autonomous braking action. Thus, the road vehicle 1 will clearly indicate that the driver has violated the agreement and that it was forced to abort the automated driving task.

According to embodiments of the method, in order to further enhance driver awareness and stress urgency, urging the driver of the road vehicle 1 to assume control of the road vehicle 1 comprises at least one of: presenting a takeover request to the infotainment display unit 3 of the infotainment system 2 of the road vehicle 1 viewed by the driver; presenting a blackout screen to the infotainment display unit 3 of the infotainment system 2 of the road vehicle 1 viewed by the driver; presenting an acoustic takeover request to an acoustic presentation unit 9 of the road vehicle 1; presenting a haptic takeover request warning to a road vehicle 1 driver contact surface 10 of the road vehicle 1. The takeover request can, of course, be presented in two or more of the above ways, in order to further enhance the ability of the driver to perceive the takeover request.

Thus, according to some embodiments the takeover request is provided through a message presented on the infotainment display unit 3 of the infotainment system 2 of the road vehicle 1 viewed by the driver, and in some embodiments the takeover request is provided through simply blacking-out the infotainment display unit, fully or partially, thus indicating to the road vehicle 1 driver that his/her focus should be returned to the task of driving the road vehicle 1. A partial black-out may be performed such that only information that is required for the task of driving the road vehicle 1 is retained on the infotainment display unit 3 whilst all other information is blacked-out. The takeover request can, when presented acoustically, be presented by an acoustic presentation unit 9 of the road vehicle 1, such as one or more loudspeakers of the in-vehicle infotainment system 2 or one or more acoustic presentation unit 9s separate therefrom, e.g. a designated acoustic presentation unit 9. When presented haptically, the takeover request can be presented e.g. through vibrating a road vehicle 1 driver contact surface 10 of the road vehicle 1, such as e.g. a steering wheel, a brake or accelerator pedal, one or more support surfaces of a road vehicle 1 driver seat etc.

The method described herein ensures that a driver can only execute a limited set of secondary tasks, while the driver can immediately be notified that he/she has to take over. As long as the eyes of the road vehicle 1 driver are focused on a display unit 3 of the road vehicle 1 controlled infotainment system 2 such a secondary task may momentarily be allowed while driving. This is made possible as the driver effectively and instantaneously can be warned and urged to return his/her focus to the task of driving should the confidence of the semi-automated driver assist system 5 drop below the threshold level. Immediate notification ability is ensured as the eyes of the driver are already on a display unit 3 of the infotainment system 2. Thus, that display unit 3 of the infotainment system 2 is suitable to be used to urge the driver of the road vehicle 1 to assume control.

Thus, the semi-automated driver assist system 5 will drive the road vehicle 1 as long as the driver uses an infotainment display unit 3 controlled by the in-vehicle infotainment system 2, and therefore, by which the driver instantly can be urged back to the task of driving the road vehicle 1.

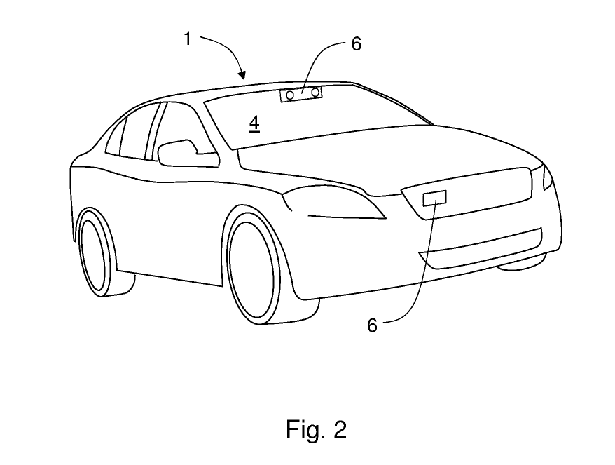

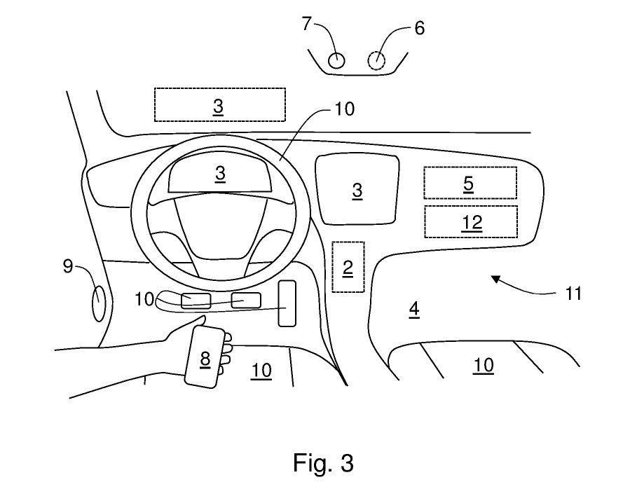

In accordance with the present disclosure is also envisaged an arrangement 11 for allowing secondary tasks during semi-automated driving of a road vehicle 1, as illustrated schematically in FIG. 2, having an infotainment system 2 which comprises one or more infotainment display units 3 arranged in a passenger compartment 4 thereof, and a semi-automated driver assist system 5 comprising one or more sensors 6 for acquiring data of a road ahead. A passenger compartment 4 of a road vehicle 1 comprising such an arrangement 11 is illustrated in FIG. 3.

The arrangement 11 comprises: a control unit 12 arranged or configured to determine, from at least the acquired data of the road ahead, a confidence of the ability of the semi-automated driver assist system 5 to control the road vehicle 1 autonomously; a driver monitoring camera 7 for determining a viewing direction of a driver of the road vehicle 1; the control unit 12 further being arranged or configured to allow autonomous control of the road vehicle 1 by the semi-automated driver assist system 5 if the viewing direction of the driver of the road vehicle 1 is determined to be towards the road ahead or towards an infotainment display unit 3 of the infotainment system 2 of the road vehicle 1 and the confidence of the ability of the semi-automated driver assist system 5 to control the road vehicle 1 autonomously is determined to be above a confidence threshold; and cancel the ongoing autonomous control by the semi-automated driver assist system 5 and urge the driver of the road vehicle 1 to assume control of the road vehicle 1 if, during ongoing autonomous control by the semi-automated driver assist system 5, the viewing direction of the driver of the road vehicle 1 is determined not to be towards the road ahead or towards an infotainment display unit 3 of the infotainment system 2 of the road vehicle 1 or the confidence of the ability of the semi-automated driver assist system 5 to control the road vehicle 1 autonomously is determined to be below a confidence threshold.

If the semi-automated driver assist system 5 has low confidence that it can continue controlling the road vehicle 1 autonomously, the in-vehicle infotainment will switch off and the driver is urged to take over immediately. Thus, in some embodiments the control unit 12 is further arranged or configured to discontinue or fade-out any ongoing presentation on the infotainment display unit 3 of the infotainment system 2 of the road vehicle 1 viewed by the driver upon urging the driver of the road vehicle 1 to assume control of the road vehicle 1. Moreover, any ongoing presentation may be discontinued or faded-out on further infotainment display units 3 than the one viewed by the driver, possibly all infotainment display units 3 of the infotainment system 2 of the road vehicle 1.

For traffic safety it is not desirable that the road vehicle 1 driver loses himself/herself using a smartphone, tablet PC or similar portable infotainment device, and therefore neglects the responsibilities associated with driving the road vehicle 1. However, in accordance with the teachings herein, under certain circumstances it may be possible to allow the driver performance of the same tasks using an infotainment system 2 controlled by the road vehicle 1. Therefore, if the driver does not look at the infotainment system 2 or not on the road, but e.g. on a nomadic device or item such as a smartphone, tablet PC or similar portable infotainment device or another portable device or item not controlled by the road vehicle 1, e.g. a book, a food item, a paper map, a shaver or similar, than any ongoing autonomous control by the semi-automated driver assist system 5 should be cancelled and the driver urged to take over. Thus, in yet some embodiments the control unit 12 is further arranged or configured to cancel any ongoing autonomous control by the semi-automated driver assist system 5 and urge the driver to assume control of the road vehicle 1 if the viewing direction of the driver of the road vehicle 1 is determined to not be towards the road ahead or towards an infotainment display unit 3 of the infotainment system 2 of the road vehicle 1, but on a nomadic device or item 8.

Should a system-error or fault occur during control of the road vehicle 1 by the semi-automated driver assist system 5 the in-vehicle infotainment should be switched off and the driver urged to take over immediately, in the same way as when the confidence of the system drops under the threshold level. Thus, according to still further embodiments the control unit 12 is further arranged or configured to determine a fault status of the semi-automated driver assist system 5, and if determined faulty discontinue or fade-out any ongoing presentation on the infotainment display unit 3 of the infotainment system 2 of the road vehicle 1 viewed by the driver and urge the driver of the road vehicle 1 to assume control of the road vehicle 1. Moreover, the control unit 12 may further be arranged or configured to discontinue or fade-out any ongoing presentation on further infotainment display units 3 than the one viewed by the driver, possibly all infotainment display units 3 of the infotainment system 2 of the road vehicle 1.

If the driver does not take over immediately when urged to do so the semi-automated driver assist system 5 should go to a degraded mode and slow down the road vehicle 1 in a safe way, e.g. through throttling down a propulsion unit of the road vehicle 1 and possibly also by performing an autonomous braking action. Thus, in yet some embodiments the control unit 12 is further arranged or configured to determine a delay in the driver of the road vehicle 1 assuming control of the road vehicle 1 following the driver of the road vehicle 1 being urged to assume control of the road vehicle 1, and if the determined delay exceeds a predetermined delay threshold, cause the semi-automated driver assist system 5 to go to a degraded mode and slow down the road vehicle 1 autonomously.

In some embodiments the control unit 12 is further arranged or configured to determine the delay in the driver of the road vehicle 1 assuming control of the road vehicle 1 from a delay in the viewing direction of the driver of the road vehicle 1 being determined to be towards the road ahead following the driver of the road vehicle 1 being urged to assume control of the road vehicle 1. Thus, should the eyes of the road vehicle 1 driver be determined not to be on the road following the driver of the road vehicle 1 being urged to assume control of the road vehicle 1, the control unit 12 should cause the semi-automated driver assist system 5 to throttle down the propulsion unit of the road vehicle 1 and possibly also perform an autonomous braking action. In this way the road vehicle 1 will clearly indicate that the driver has violated the agreement and that it was forced to abort the automated driving task.

According to some embodiments, in order to further enhance driver awareness and stress urgency, the control unit 12 is further arranged or configured to urge the driver of the road vehicle 1 to assume control of the road vehicle 1 by at least one of: presenting a takeover request to the infotainment display unit 3 of the infotainment system 2 of the road vehicle 1 viewed by the driver; presenting a blackout screen to the infotainment display unit 3 of the infotainment system 2 of the road vehicle 1 viewed by the driver; presenting an acoustic takeover request to an acoustic presentation unit 9 of the road vehicle 1; presenting a haptic takeover request warning to a road vehicle 1 driver contact surface 10 of the road vehicle 1. The takeover request can, of course, be presented in two or more of the above ways, in order to further enhance the ability of the driver to perceive the takeover request.

Thus, according to some embodiments the control unit 12 is further arranged or configured to provide the takeover request through a message presented on the infotainment display unit 3 of the infotainment system 2 of the road vehicle 1 viewed by the driver, and in some embodiments the control unit 12 is further arranged or configured to provide the takeover request through simply blacking-out the infotainment display unit, fully or partially, thus indicating to the road vehicle 1 driver that his/her focus should be returned to the task of driving the road vehicle 1. A partial black-out may be performed such that only information that is required for the task of driving the road vehicle 1 is retained on the infotainment display unit 3 whilst all other information is blacked-out. The takeover request can, when being caused by the control unit 12 further to be presented acoustically, be arranged or configured to be presented by an acoustic presentation unit 9 of the road vehicle 1, such as one or more loudspeakers of the in-vehicle infotainment system 2 or one or more acoustic presentation units 9 separate therefrom, e.g. a designated acoustic presentation unit 9. When being caused by the control unit 12 further to be presented haptically, the takeover request can be presented e.g. through vibrating a road vehicle 1 driver contact surface 10 of the road vehicle 1, such as e.g. a steering wheel, a brake or accelerator pedal, one or more support surfaces of a road vehicle 1 driver seat etc.

It should be noted that the control unit 12 described herein may refer to and/or comprise a combination of analog and digital circuits and/or one or more processors and memory configured with software and/or firmware, e.g., stored in the memory, that when executed by the one or more processors perform the functions and/or operations described herein. One or more of such processors, as well as other digital hardware, may be included in a single ASIC (Application-Specific Integrated Circuitry), or several processors and various digital hardware may be distributed among several separate components, whether individually packaged or assembled into a SoC (System-on-a-Chip).

The method and arrangement 11 described herein strive to encourage a suitable behavior of the driver and eliminate any unsuitable behavior by allowing secondary tasks performed in a safe manner where the road vehicle 1 is able to instantaneously bring the driver back into the control-loop should it be deemed necessary.

In accordance with the present disclosure is also envisaged a road vehicle 1, comprising an arrangement 11 as described in the foregoing.

A road vehicle 1 which comprises an arrangement 11, as above, will allow a driver the performance of limited secondary tasks, using an infotainment system 2 controlled by the road vehicle 1, while ensuring that the driver can immediately be notified that he/she has to take over the task of driving the road vehicle 1.

The above-described embodiments may be varied within the scope of the following claims.

Thus, while there have been shown and described and pointed out fundamental novel features of the embodiments herein, it will be understood that various omissions and substitutions and changes in the form and details of the devices illustrated, and in their operation, may be made by those skilled in the art. For example, it is expressly intended that all combinations of those elements and/or method steps which perform substantially the same function in substantially the same way to achieve the same results are equivalent. Moreover, it should be recognized that structures and/or elements and/or method steps shown and/or described in connection with any disclosed form or embodiment herein may be incorporated in any other disclosed or described or suggested form or embodiment as a general matter of design choice.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for allowing secondary tasks during semi-automated driving of a road vehicle having an infotainment system which comprises one or more infotainment display units arranged in a passenger compartment thereof, and a semi-automated driver assist system including one or more sensors for acquiring data of a road ahead, the method comprising:
determining, from at least the acquired data of the road ahead, a confidence of the ability of the semi-automated driver assist system to control the road vehicle autonomously;
determining a viewing direction of a driver of the road vehicle using a driver monitoring camera;
if the viewing direction of the driver of the road vehicle is determined to be towards the road ahead or towards an infotainment display unit of the infotainment system of the road vehicle and the confidence of the ability of the semi-automated driver assist system to control the road vehicle autonomously is determined to be above a confidence threshold, allowing autonomous control of the road vehicle by the semi-automated driver assist system; and
if, during ongoing autonomous control by the semi-automated driver assist system, the viewing direction of the driver of the road vehicle is determined not to be towards the road ahead or towards an infotainment display unit of the infotainment system of the road vehicle or the confidence of the ability of the semi-automated driver assist system to control the road vehicle autonomously is determined to be below a confidence threshold, cancelling the ongoing autonomous control by the semi-automated driver assist system and urging the driver of the road vehicle to assume control of the road vehicle.

2. The method according to claim 1 further comprising discontinuing or fading-out any ongoing presentation on the infotainment display unit of the infotainment system of the road vehicle viewed by the driver upon urging the driver of the road vehicle to assume control of the road vehicle.

3. The method according to claim 1 wherein, if the viewing direction of the driver of the road vehicle is determined to not be towards the road ahead or towards an infotainment display unit of the infotainment system of the road vehicle, but on a nomadic device or item, then cancelling any ongoing autonomous control by the semi-automated driver assist system and urging the driver to assume control of the road vehicle.

4. The method according to claim 1 further comprising determining a fault status of the semi-automated driver assist system and if determined faulty, discontinuing or fading-out any ongoing presentation on the infotainment display unit of the infotainment system of the road vehicle viewed by the driver and urging the driver of the road vehicle to assume control of the road vehicle.

5. The method according to claim 1 further comprising determining a delay in the driver of the road vehicle to assuming control of the road vehicle following the driver of the road vehicle being urged to assume control of the road vehicle, and if the determined delay exceeds a predetermined delay threshold, causing the semi-automated driver assist system to go to a degraded mode and slow down the road vehicle autonomously.

6. The method according to claim 5 wherein the delay in the driver of the road vehicle assuming control of the road vehicle is determined from a delay in the viewing direction of the driver of the road vehicle being determined to be towards the road ahead following the driver of the road vehicle being urged to assume control of the road vehicle.

7. The method according to claim 1 wherein urging the driver of the road vehicle to assume control of the road vehicle comprises at least one of: presenting a takeover request to the infotainment display unit of the infotainment system of the road vehicle viewed by the driver; presenting a blackout screen to the infotainment display unit of the infotainment system of the road vehicle viewed by the driver; presenting an acoustic takeover request to an acoustic presentation unit of the road vehicle; presenting a haptic takeover request warning to a road vehicle driver contact surface of the road vehicle.

8. An arrangement for allowing secondary tasks during semi-automated driving of a road vehicle having an infotainment system including one or more infotainment display units arranged in a passenger compartment thereof, and a semi-automated driver assist system having one or more sensors for acquiring data of a road ahead, the arrangement comprising:
a control unit configured to determine, from at least the acquired data of the road ahead, a confidence of the ability of the semi-automated driver assist system to control the road vehicle autonomously; and
a driver monitoring camera for determining a viewing direction of a driver of the road vehicle;
the control unit further configured to
allow autonomous control of the road vehicle by the semi-automated driver assist system if the viewing direction of the driver of the road vehicle is determined to be towards the road ahead or towards an infotainment display unit of the infotainment system of the road vehicle and the confidence of the ability of the semi-automated driver assist system to control the road vehicle autonomously is determined to be above a confidence threshold, and
during ongoing autonomous control by the semi-automated driver assist system, cancel the ongoing autonomous control by the semi-automated driver assist system and urge the driver of the road vehicle to assume control of the road vehicle if the viewing direction of the driver of the road vehicle is determined not to be towards the road ahead or towards an infotainment display unit of the infotainment system of the road vehicle or the confidence of the ability of the semi-automated driver assist system to control the road vehicle autonomously is determined to be below a confidence threshold.

9. The arrangement according to claim 8 wherein the control unit further is configured to discontinue or fade-out any ongoing presentation on the infotainment display unit of the infotainment system of the road vehicle viewed by the driver upon urging the driver of the road vehicle to assume control of the road vehicle.

10. The arrangement according to claim 8 wherein the control unit further is configured to cancel any ongoing autonomous control by the semi-automated driver assist system and urge the driver to assume control of the road vehicle if the viewing direction of the driver of the road vehicle is determined to not be towards the road ahead or towards an infotainment display unit of the infotainment system of the road vehicle, but on a nomadic device or item.

11. The arrangement according to claim 8 wherein the control unit further is configured to determine a fault status of the semi-automated driver assist system, and if determined faulty discontinue or fade-out any ongoing presentation on the infotainment display unit of the infotainment system of the road vehicle viewed by the driver and urge the driver of the road vehicle to assume control of the road vehicle.

12. The arrangement according to claim 8 wherein the control unit further is configured to determine a delay in the driver of the road vehicle assuming control of the road vehicle following the driver of the road vehicle being urged to assume control of the road vehicle, and if the determined delay exceeds a predetermined delay threshold, cause the semi-automated driver assist system to go to a degraded mode and slow down the road vehicle autonomously.

13. The arrangement according to claim 12 wherein the control unit further is configured to determine the delay in the driver of the road vehicle assuming control of the road vehicle from a delay in the viewing direction of the driver of the road vehicle being determined to be towards the road ahead following the driver of the road vehicle being urged to assume control of the road vehicle.

14. An arrangement according to claim 8 wherein the control unit further is configured to urge the driver of the road vehicle to assume control of the road vehicle by at least one of: presenting a takeover request to the infotainment display unit of the infotainment system of the road vehicle viewed by the driver; presenting a blackout screen to the infotainment display unit of the infotainment system of the road vehicle viewed by the driver; presenting an acoustic takeover request to an acoustic presentation unit of the road vehicle; presenting a haptic takeover request warning to a road vehicle driver contact surface of the road vehicle.

15. A road vehicle comprising an arrangement according to claim 8.
